(19) United States
(12) Patent Application Publication
(10) Pub. No.: US 2024/0221181 A1
(43) Pub. Date: Jul. 4, 2024

(54) IMAGE PROCESSING SYSTEM

(71) Applicant: Hitachi Kokusai Electric Inc., Minato-ku, Tokyo (JP)

(72) Inventor: Hiroto SASAO, Tokyo (JP)

(21) Appl. No.: 18/570,934

(22) PCT Filed: Sep. 16, 2021
(86) PCT No.: PCT/JP2021/034106

§ 371 Date: Dec. 15, 2023

(51) Int. Cl. G06T 7/20; G06T 3/40; G06T 7/70

(52) U.S. Cl. CPC G06T 7/20; G06T 3/40; G06T 7/70

(57) ABSTRACT

An object of the present invention is to improve the accuracy of tracking based on image processing. The image processing system of the present invention includes an object detection unit that detects an object with respect to image data using a learning model, and an object tracking unit. The object tracking unit creates a reference template in which are set a cutout image obtained by resizing the detected object from image data of a predetermined number-th frame and center coordinates, creates a temporary template in which are set a cutout image obtained by resizing the detected object from image data of the next frame and center coordinates, extracts a template pair for which a match is established under a predetermined condition, and updates the reference template by creating a template in which are set a cutout image having pixel values obtained by taking into account a predetermined amount of a pixel value of the cutout image of the pair reference template and a pixel value of a cutout image of the pair temporary template and the center coordinates of the pair temporary template, and retains remaining reference templates and temporary templates for updating as reference templates.

### TECHNICAL FIELD

The present invention relates to an image processing system, an image processing device, and an image processing method.

### BACKGROUND OF THE INVENTION

One of the functions of conventional image processing systems includes object tracking. This function is, for example, a technique capable of automatically detecting a suspicious person and tracking the suspicious person so that they are not missed. Conventional techniques are often implemented using relatively simple algorithms, such as the finite difference method. In addition, in recent research, techniques for performing advanced computation using Deep Learning have been developed.

For example, Patent Document 1 discloses a technique in which, when a plurality of objects are detected from an image signal by a finite difference method, the average ratio of a histogram of a divided image obtained by dividing the input image signal and a reference background image signal pixel by pixel is calculated for each detected object, and it is determined whether or not an intruding object is a monitoring target.

Furthermore, Patent Literature 2 discloses a technique related to a process of determining an appropriate binarization threshold to remove noise and detect intruding objects when performing object detection by calculating a difference value for each pixel between an input image and a reference background image and comparing the difference value with a binarization threshold value.

### CITATION LIST

### Patent Documents

[Patent Document 1] Japanese Unexamined Patent Application Publication No. 2001-175959 A
[Patent Document 2] Japanese Unexamined Patent Application Publication No. 2002-218443 A

### SUMMARY OF INVENTION

### Technical Problem

However, in finite difference methods, since basically anything that moves is detected, there is a problem that objects (such as cars or tree leaves) other than the target detection object (for example, a person) are also detected, such that false alarms are more likely to occur.

Object tracking methods using Deep Learning can be expected to have higher detection accuracy, but there are problems associated with the difficulty of real-time performance due to the large amount of calculations and the high power consumption of the hardware configuration needed to compensate for the calculation load.

Further, in the case of performing person tracking using images, when tracking is performed using a reference template updated to the latest image of the person, tracking is performed based on an image that may appear differently due to the temporary movement of the person being tracked, such that the person may be eventually lost and tracking accuracy decreases. In addition, if a vehicle temporarily passes in front of a person (occlusion), the next tracking is performed based on the latest image in which the person and the vehicle overlap each other, such that the person may be eventually lost and tracking accuracy decreases.

Patent Literature 1 and Patent Literature 2 do not recognize the above-described problems in which the similarity of the person or object serving as the tracking target changes.

Therefore, it is an object of the present invention to provide an image processing technique that uses a hardware configuration that reduces power consumption and that has object tracking functionality with higher detection accuracy than conventional techniques.

### Means for Solving the Problems

In order to solve the above problem, one representative image processing system according to the present invention includes an object detection unit that detects an object with respect to image data using a learning model, and an object tracking unit. The object tracking unit creates a reference template in which are set a cutout image obtained by resizing the detected object from image data of a predetermined number-th frame and center coordinates, creates a temporary template in which are set a cutout image obtained by resizing the detected object from image data of the next frame and center coordinates, extracts a template pair for which a match is established under a predetermined condition, updates the reference template by creating a template in which are set a cutout image having pixel values obtained by taking into account a predetermined amount of a pixel value of the cutout image of the pair reference template and a pixel value of a cutout image of the pair temporary template and the center coordinates of the pair temporary template, and retains remaining reference templates and temporary templates for updating as reference templates

### Advantageous Effects of Invention

According to the present invention, it is possible to provide an image processing technique that has object tracking functionality with higher detection accuracy than conventional techniques.

Problems, configurations, and effects other than those described above will become apparent from the following description of the embodiments.

### BRIEF DESCRIPTION OF DRAWINGS

FIG. 1 is a block diagram illustrating a configuration of an image processing system according to the present embodiments.

FIG. 2 is a block diagram illustrating a configuration of the image processing unit 103 according to the present embodiments.

FIG. 3 is a flowchart of the image processing unit 103 according to the present embodiments.

FIG. 4 is a diagram illustrating a process of creating a template of a tracked person from image data according to the present embodiments.

FIG. 5 is a diagram illustrating a matching process between a reference template and a temporary template according to the present embodiments.

FIG. 6 is a diagram illustrating a process of updating a reference template using a pair template according to the present embodiments.

FIG. 7 is a diagram illustrating processing for templates for which a match has not been established, according to the present embodiments.

### DESCRIPTION OF EMBODIMENT(S)

Hereinafter, embodiments of the present invention will be described with reference to the drawings. It should be noted that the present invention is not limited to these embodiments. In addition, in the description of the drawings, the same parts are denoted by the same reference numerals.

In the present disclosure, the term “image data” refers to the data of an image captured within the imaging field of view (sometimes referred to as a “frame”) of an imaging device, unless otherwise specified.

In the present disclosure, the position of a detected object or the like may be represented by coordinates (x, y) by using XY coordinates. In this case, the position of the origin is not particularly limited, but for example, the position of a pixel (in units of pixels) can be identified when the uppermost left of the frame is set to the origin (0, 0), the right direction is the positive direction of the X-axis, and the down direction is the positive direction of the Y-axis.

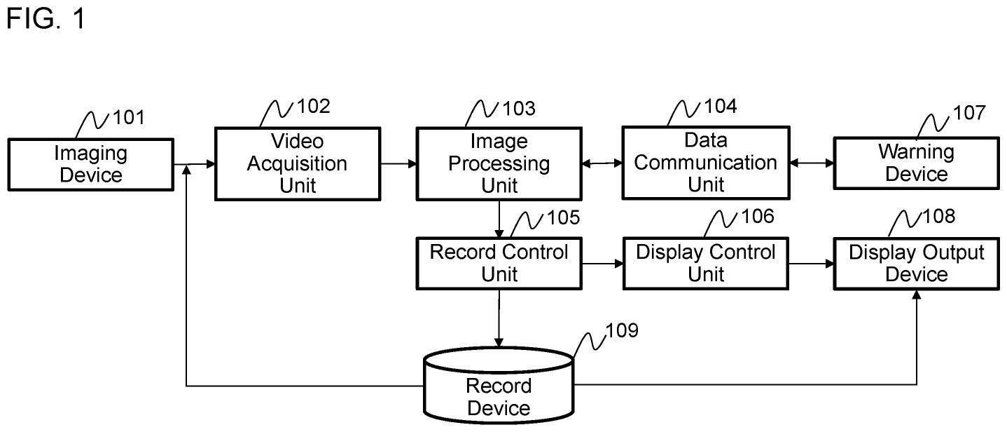

First, the configuration of an image processing system according to the present embodiments will be described. FIG. 1 is a block diagram illustrating the configuration of an image processing system according to the present embodiments.

The hardware of the image-processing system may be constituted by an electronic computer system equipped with a general-purpose CPU such that each respective function can be executed. The CPU may be replaced by Digital Signal Processor (DSP), a Field-Programmable Gate Array (FPGA), or Graphics Processing Unit (GPU).

The imaging device 101 is a device such as one or more IP cameras that are fixedly or movably installed to capture images.

The video acquisition unit 102 has a function for acquiring a real-time video signal from the imaging device 101 or a video signal recorded by the record device 109 as image data having a one-dimensional array, a two-dimensional array, or a three-dimensional array.

The image data may be subjected to processing such as a smoothing filter, an edge enhancement filter, density conversion, or the like as preprocessing in order to reduce the effects of noise, flicker, and the like. Furthermore, data formats such as RGB color, YUV, and monochrome may be selected depending on the purpose. Furthermore, in order to reduce processing costs, the image data may be reduced to a predetermined size.

The image processing unit 103 has a function of detecting and tracking a specific object by image processing using image data obtained from the video acquisition unit 102 as an input.

The data communication unit 104 has a function of transmitting and receiving signals detected and processed by the image processing unit 103, signals from a monitoring center on a network, or the like.

The record control unit 105 has a function of controlling the recording of image data detected and processed by the image processing unit 103, and controlling the compression ratio and the recording interval of the recorded images.

The display control unit 106 has a function of controlling the display of videos acquired by the video acquisition unit 102, the results detected by the image processing unit 103, and the information stored in the record device 109.

The warning device 107 is, for example, a device such as an alarm or a warning light that notifies the user of the results of the detection processing by the image processing unit 103 using sound or light.

The display output device 108 is a device that displays the videos acquired by the video acquisition unit 102, the result of the detection and processing performed by the image processing unit 103, and the information stored in the record device 109.

The record device 109 is an apparatus that records and stores the videos obtained from the video acquisition unit 102 and the results of the detection and processing performed by the image processing unit 103 according to commands from the record control unit 105.

Next, the image processing unit 103 will be described in detail.

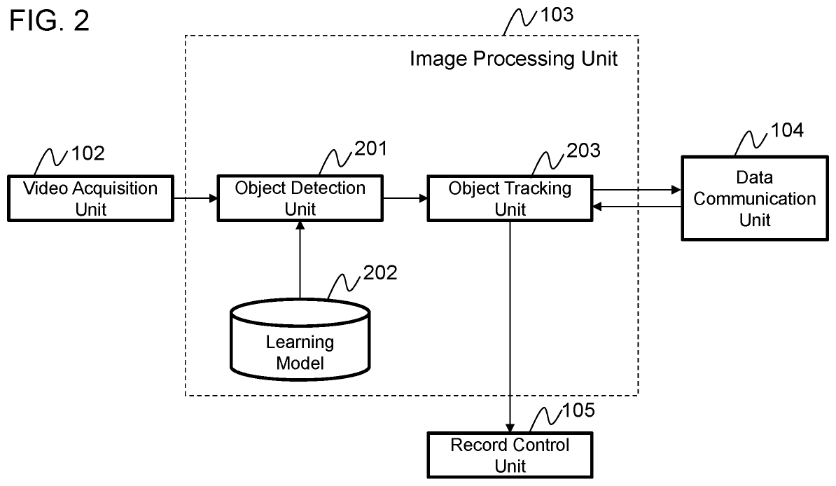

FIG. 2 is a block diagram illustrating a configuration of the image processing unit 103 according to the present embodiments. The image processing unit 103 includes an object detection unit 201, a learning model 202, and an object tracking unit 203.

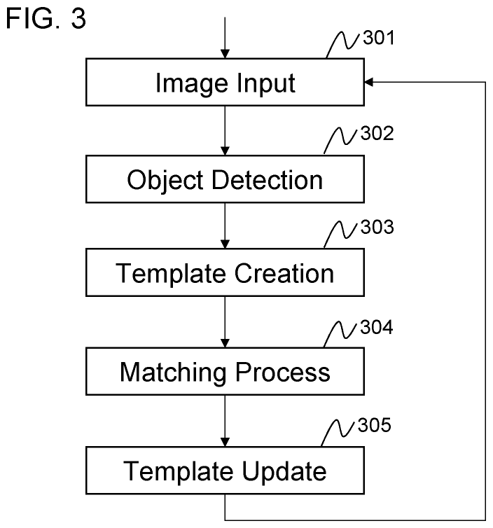

FIG. 3 is a flowchart illustrating the processing performed by the image processing unit 103 according to the present embodiments. The image input step 301 is a step of inputting the image data acquired by the video acquisition unit 102. The object detection step 302 is a step of detecting a target tracking object. The template creation step 303 is a step of creating a template for the detected object information. The matching process step 304 is a step of performing a matching process for connecting templates between frames. The template update step 305 is a step of updating the template. Subsequently, the process returns to the image input step 301 and repeats the processing.

### <Object Detection>

Next, the object detection of the object detection unit 201 and the object detection step 302 that occurs therein will be described.

In the object detection unit 201 and the object detection step 302, a target tracking object is detected with respect to the image data acquired by the video acquisition unit 102 using a learning model 202 created by machine learning in advance, and the position in the image is output.

As the machine-learning technique, an object detection method such as the well-known Deep Learning may be applied, or Fast R-CNN, Faster R-CNN, YOLO, SSD, or the like may be used.

### <Object Tracking>

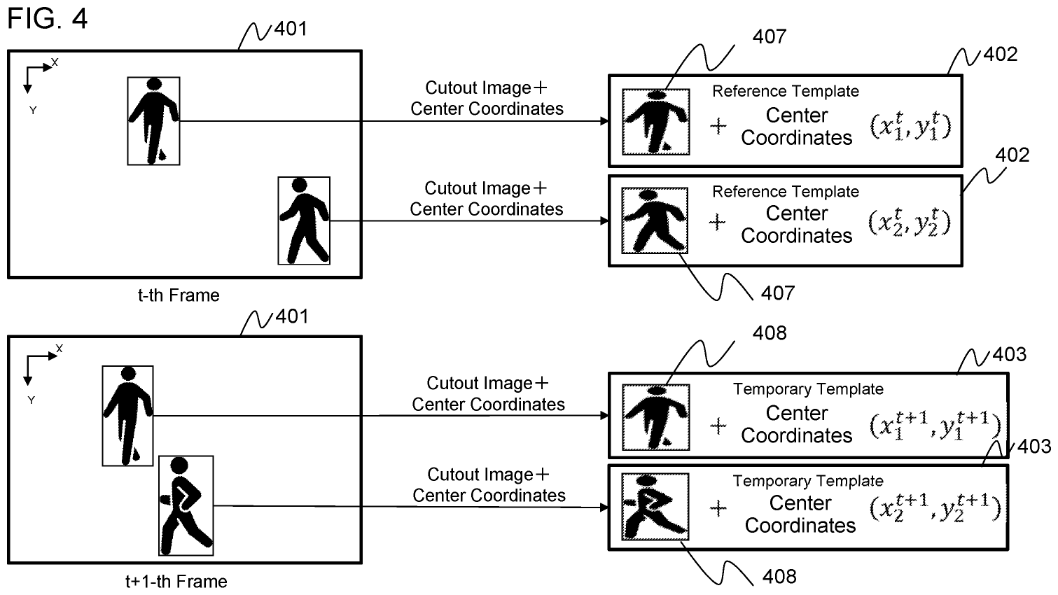

Next, the object tracking unit 203 and the template creation step 303, the matching process step 304, and the template update step 305 that occur therein will be described with reference to FIG. 4 to FIG. 7, using person tracking as an example. It should be noted that it goes without saying that the tracking target according to the technique of the present disclosure is not limited to a person.

### [Template Creation]

FIG. 4 is a diagram illustrating a process of creating a template of a tracked person from image data in the present embodiment.

From the image data 401 of the t-th frame obtained from the video acquisition unit 102, the object detection unit 201 detects a person surrounded by a bounding box by a method using a learning model 202 created in advance by machine learning (object detection step 302). The size of the bounding box is determined according to the motion and size of the detected person.

In the present disclosure, the “t-th frame” means the t-th captured frame sequentially counted from a frame captured at a certain point in time. However, the frame serving as the start point of the count is not particularly limited.

Next, a cutout image 407 is created by resizing the bounding boxes of respective sizes to a fixed size of W pixels×H pixels, and a reference template 402 in which the cutout image 407 and its center coordinates (x′, y′) are set as one set is created for each of the number of detected people (template creation step 303).

For example, in the case that the image data is 640 pixels wide by 480 pixels high (24 bits per pixel), it can be assumed that the image data is resized to a fixed size of 70 pixels (W)×70 pixels (H), but the present invention is not limited thereto.

In the image data 401, by uniformly resizing people detected with bounding box sizes of different sizes to a size of W×H, it becomes possible to perform arithmetic processing such as SSD (to be described later). In addition, by reducing the number of pixels by resizing, it is also possible to reduce the processing load on the computer.

Similarly, from the image data 401 of the next t+1-th frame, a temporary template 403 in which a cutout image 408 of a person automatically resized to W pixels×H pixels and its center coordinates (x^{t+1}, y^{t+1}) are set as one set is created for each of the number of detected people (template creation step 303).

### [Matching Process]

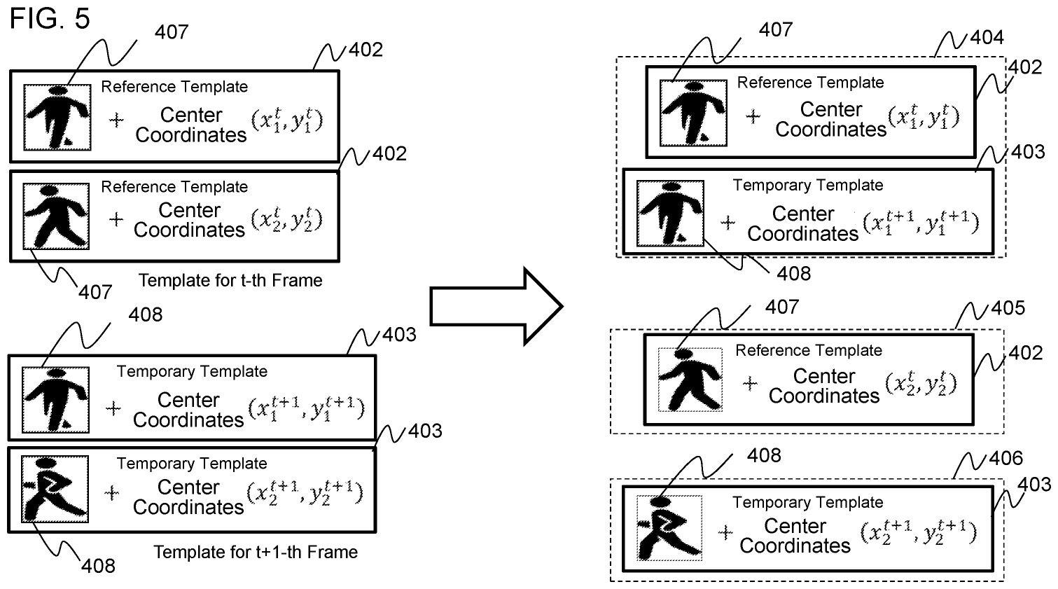

Next, with reference to FIG. 5, a process of selecting a combination of a reference template and a temporary template that satisfy a predetermined condition (hereinafter, sometimes referred to as “matching”) in the object tracking unit 203 will be described (matching process step 304).

FIG. 5 is a diagram illustrating a matching process between a reference template and a temporary template according to the present embodiments.

As an example of the predetermined condition, a template 404 (hereinafter, referred to as a “template pair”) is extracted by combining a reference template 402 and a temporary template 403 in which the distance L pixels between the center coordinates of the reference template 402 and the temporary template 403 is less than or equal to a threshold R pixels, and the similarity SSD (Sum of Squared Differences) between the cutout image 407 of the reference template 402 and the cutout image 408 of the temporary template is less than or equal to a threshold D. Hereinafter, the reference template included in the template pair is referred to as a “pair reference template,” and the temporary template included in the template pair is also referred to as a “pair temporary template.”

The distance L pixels is shown in Equation 1, and the similarity SSD is shown in Equation 2.

$$L = \sqrt{{( {x}_{1} - {x}_{2} )}^{2} + {( {y}_{1} - {y}_{2} )}^{2}} \qquad [ Equation 1 ]$$

$$SSD = {{\sum }_{i = 0}}^{W} {{\sum }_{j = 0}}^{H} {( f ( i , j ) - g ( i , j ) )}^{2} \qquad [ Equation 2 ]$$

Here, it is assumed that the center coordinate of the reference template 402 is (x₁, y₁), the center coordinate of the temporary template 403 is (x₂, y₂), the pixel value of the position (i, j) of the reference template 402 is f(i, j), and the pixel value of the position (i, j) of the temporary template 403 is g(i, j).

It should be noted that, although SSD is used for the similarity calculation, it is also possible to use Sum of Absolute Difference (SAD), Normalized Cross-Correlation (NCC), or Zero-means Normalized Cross-Correlation (ZNCC).

At this time, there may be cases in which one reference template 402 may satisfy the conditions for combination with a plurality of temporary templates 403. Similarly, there may be cases when one temporary template 403 may satisfy the conditions for combination with multiple reference templates 402. In such cases, the combination with the smallest similarity SSD is selected. Thus, the reference template 402 and the temporary template 403 are always combined in a one-to-one manner.

Conversely, there may be cases in which a combination is not established. At that time, the remaining reference templates 405 and the remaining temporary templates 406 are also extracted.

For example, in an environment in which a person appears at a close distance and occlusion is likely to occur, by setting W=H=70 pixels, a threshold R=200 pixels for the distance L, and a similarity SSD threshold of D=0.6 (where SSD is normalized to between 0 to 1), the reference template 402 and the temporary template 403 may be more easily combined even if the person moves relatively significantly in the image. Here, occlusion refers to a part or the whole of a target person being hidden by a person other than the target person, a moving body such as a car, bus, motorcycle, bicycle, train, airplane, or helicopter, a natural object such as animals or plants, or other artificial objects.

### [Template Update]

Next, the process of updating the template in the object tracking unit 203 will be described (template update step 305).

### (Update Using Template Pair)

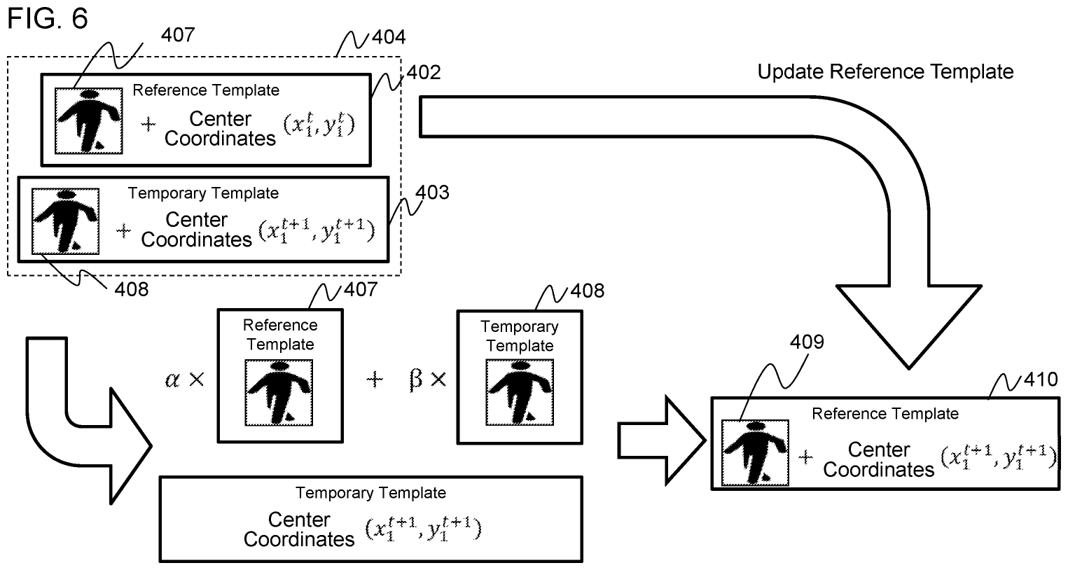

FIG. 6 is a diagram illustrating a process of updating a reference template using a template pair according to the present embodiments.

In the template pair 404 for which matching was established, the reference template is replaced and updated with a set including a cutout image 409 having pixel values obtained by taking into account a predetermined amount of the pixel values of the cutout image 407 of the pair reference template 402 and the pixel values of the cutout image 408 of the pair temporary template 403 and the center coordinates (x₁^{t+1}, y₁^{t+1}) of the paired temporary template 403, and this reference template 410 will be treated as the tracking target from this point on.

As illustrated in Equation 3, as the predetermined amount, a pixel value that is the sum of a value obtained by multiplying a pixel value of the cutout image 407 of the pair reference template 402 by a predetermined ratio α and a value obtained by multiplying a pixel value of the cutout image 408 of the pair temporary template 403 by a predetermined ratio β (=1−α) may be set as the pixel value of the cutout image 409 of the updated reference template 410.

$${f}^{′} ( i , j ) = α \times f ( i , j ) + β \times g ( i , j ) \qquad [ Equation 3 ]$$

f′(i, j) is the pixel value of the position (i, j) of the updated reference template 410, where α+β=1.

α and β may be set in accordance with the environment to be image captured, the behavior of a tracking person, or the like. For example, in an environment in which a person appears at a close distance and occlusion is likely to occur, it is conceivable to set α=0.9 and β=0.1 such that a large amount of pixel value information for the person in the original reference template 402 can be left and tracking can be continued even after the occlusion disappears. Conversely, in a scene in which a person appears at a far distance and occlusion is unlikely to occur, the ratio of a may be lowered and the ratio of β may be increased. In addition, in a scene in which the person being tracked temporarily puts on or takes off a coat or jacket, it is conceivable to set the ratios of α and β to be approximately the same. However, it should be noted that the above is merely an example.

In practice, it is expected that the performance of object tracking can be improved by repeatedly setting various parameters (the size W pixels×H pixels of the reference template 402 and temporary template 403, the threshold R pixels for the distance L, the threshold D for the similarity SSD, and the α and β to be used when updating the reference template 402) according to each environment and scene, confirming the actual behavior, and then readjusting each parameter. The parameters may be set manually or automatically by a computer.

### Operation and Advantageous Effect

By updating the reference template using the template pair, compared to methods of tracking a target person based on a reference template (α=0 and β=1) using the latest image data, the pixel value information of the person in previous reference templates can be taken into consideration, and even when the similarity of the tracked person changes due to occlusion, temporary movement of the person, or detection failure, or the like, it becomes possible to improve the tracking accuracy without losing sight of the target.

(Update with Remaining Templates)

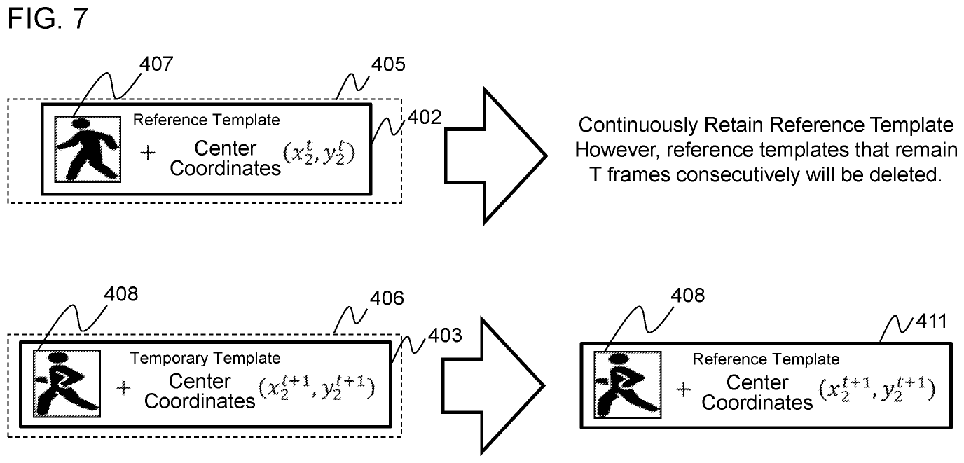

Furthermore, a process will be described in which the reference template is updated in the object tracking unit 203 using the templates that remain after a match is not established in the matching process step 304 (template update process step 305). FIG. 7 is a diagram illustrating processing for templates for which a match has not been established, according to the present embodiments.

The excess reference template 405 described in FIG. 5 is continuously retained and updated as a reference template for use in the subsequent combination extraction step. However, in the case it remains T frames consecutively, it will be deleted. In addition, the remaining temporary template 406 is replaced and updated as a new reference template 411 while the cutout image 408 and the center coordinates are retained.

### Operation and Advantageous Effect

By updating the reference template using the remaining templates, in the case that a certain tracked person is detected in a first image capture and the cutout image becomes the reference template, but an appropriate cutout image cannot be obtained and matching cannot be achieved due to detection failure or occlusion in a second image capture, by continuously retaining the image without deleting it, there is an advantageous effect that matching can be achieved and the same person can be tracked in a third image capture if the obstruction is removed and a suitable cutout image is obtained once again. However in case it remains in the long term, it will be deleted if it remains T frames consecutively because the value to retain will reduce over time.

For example, in an environment in which a person appears at a close distance and occlusion is likely to occur, by setting T=10 frames, it is possible to continuously track the target person even if the target person is momentarily lost in the middle due to occlusion.

Although the embodiments of the present invention have been described above, the present invention is not limited to the above-described embodiments, and various modifications can be made without departing from the gist of the present invention.

Further, for example, the image processing device can be understood as an image processing device equipped with an object detection device or an object tracking device operated by a computer having a CPU and a memory programmed to perform the functions of the image processing system according to the present embodiments.

Furthermore, the invention can also be understood as a program for causing a computer to execute the functions of the image processing system according to the present embodiments, for example. In that case, the invention may be as follows.
“1. A program for causing a computer that sends and receives data between a video acquisition unit, a data communication unit, and a record control unit to perform:
   an image input process of inputting image data from a video acquisition unit;
   an object detection process of detecting, with respect to image data acquired by a video acquisition unit, a target tracking object using a learning model created in advance by machine learning, and outputs a position in the image; and
   a template creation process of creating, from the image data, a reference template or a temporary template in which are set a cutout image obtained by resizing a detected object to a particular size (W×H) and center coordinates;
   a matching process of extracting a template pair consisting of a pair reference template and a pair temporary template in a one-to-one manner for which a match is established under a predetermined condition; and
   a template update process of updating a reference template by creating a template in which are set a cutout image having pixel values obtained by taking into account a predetermined amount of a pixel value of a cutout image of the pair reference template and a pixel value of a cutout image of the pair temporary template and the center coordinates of the pair temporary template; and retaining reference templates and temporary templates remaining from a match not being established for updating as reference templates.
2. The program according to 1, wherein the predetermined condition is that a distance L pixels between center coordinates of the reference template and the temporary template to be matched is less than or equal to a predetermined threshold, and an SSD between cutout images is a minimum value that is less than or equal to a threshold.
3. The program according to 2, wherein the predetermined amount is a pixel value that is the sum of a value obtained by multiplying a pixel value of a cutout image of the pair reference template by a predetermined ratio α and a value obtained by multiplying a pixel value of a cutout image of the pair temporary template by a predetermined ratio β (=1−α).
4. The program according to any one of 1 to 3, wherein, among reference templates remaining from a match not being established, reference templates that remain for a predetermined number of frames consecutively are deleted.

### REFERENCE SIGNS LIST

101 . . . Imaging device, 102 . . . Video acquisition unit, 103 . . . Image processing unit, 104 . . . Data communication unit, 105 . . . Record control unit, 106 . . . Display control unit, 107 . . . Warning device, 108 . . . Display output device, 109 . . . Record device, 201 . . . Object detection unit, 202 . . . Learning model, 203 . . . Object tracking unit, 301 . . . Image input step, 302 . . . Object detection step, 303 . . . Template creation step, 304 . . . Matching step, 305 . . . Template update step, 401 . . . Image data, 402, 405, 410, 411 . . . Reference template, 403, 406 . . . Temporary template, 404 . . . Template pair, 407, 408, 409 . . . Cutout image

1. An image processing system comprising:
an object detection unit that detects, with respect to image data acquired by a video acquisition unit, a target tracking object using a learning model created in advance by machine learning, and outputs a position in the image; and
an object tracking unit that tracks a detected object over multiple frames;
wherein the object tracking unit is configured to:
create a reference template in which are set a cutout image obtained by resizing a detected object to a particular size (W×H) from image data of a predetermined number-th frame and center coordinates, and create a temporary template in which are set a cutout image obtained by resizing a detected object to a particular size (W×H) from image data of a next frame and center coordinates;
extract a template pair consisting of a pair reference template and a pair temporary template in a one-to-one manner for which a match is established under a predetermined condition; and
update a reference template by creating a template in which are set a cutout image having pixel values obtained by taking into account a predetermined amount of a pixel value of a cutout image of the pair reference template and a pixel value of a cutout image of the pair temporary template and the center coordinates of the pair temporary template, and retain reference templates and temporary templates remaining from a match not being established for updating as reference templates.

2. The image processing system according to claim 1, wherein the predetermined condition is that a distance L pixels between center coordinates of the reference template and the temporary template to be matched is less than or equal to a predetermined threshold, and an SSD between cutout images is a minimum value that is less than or equal to a threshold.

3. The image processing system according to claim 2, wherein the predetermined amount is a pixel value that is the sum of a value obtained by multiplying a pixel value of a cutout image of the pair reference template by a predetermined ratio α and a value obtained by multiplying a pixel value of a cutout image of the pair temporary template by a predetermined ratio β (=1−α).

4. The image processing system according to claim 1, wherein, among reference templates remaining from a match not being established, reference templates that remain for a predetermined number of frames consecutively are deleted.

5. An image processing device operated by a computer comprising:
an object detection device that detects, with respect to image data acquired by a video acquisition unit, a target tracking object using a learning model created in advance by machine learning, and outputs a position in the image; and
an object tracking device that tracks a detected object over multiple frames;
wherein the object tracking device is configured to:
create a reference template in which are set a cutout image obtained by resizing a detected object to a particular size (W×H) from image data of a predetermined number-th frame and center coordinates, and create a temporary template in which are set a cutout image obtained by resizing a detected object to a particular size (W×H) from image data of a next frame and center coordinates;
extract a template pair consisting of a pair reference template and a pair temporary template in a one-to-one manner for which a match is established under a predetermined condition; and
update a reference template by creating a template in which are set a cutout image having pixel values obtained by taking into account a predetermined amount of a pixel value of a cutout image of the pair reference template and a pixel value of a cutout image of the pair temporary template and the center coordinates of the pair temporary template, and retain reference templates and temporary templates remaining from a match not being established for updating as reference templates.

6. The image processing device according to claim 5, wherein the predetermined condition is that a distance L pixels between center coordinates of the reference template and the temporary template to be matched is less than or equal to a predetermined threshold, and an SSD between cutout images is a minimum value that is less than or equal to a threshold.

7. The image processing device according to claim 6, wherein the predetermined amount is a pixel value that is the sum of a value obtained by multiplying a pixel value of a cutout image of the pair reference template by a predetermined ratio α and a value obtained by multiplying a pixel value of a cutout image of the pair temporary template by a predetermined ratio β (=1−α).

8. The image processing device according to claim 5, wherein, among reference templates remaining from a match not being established, reference templates that remain for a predetermined number of frames consecutively are deleted.

9. An image processing method comprising:
an image input step of inputting image data from a video acquisition unit;
an object detection step of detecting, with respect to image data acquired by a video acquisition unit, a target tracking object using a learning model created in advance by machine learning, and outputs a position in the image; and
a template creation step of creating, from the image data, a reference template or a temporary template in which are set a cutout image obtained by resizing a detected object to a particular size (W×H) and center coordinates;
a matching process step of extracting a template pair consisting of a pair reference template and a pair temporary template in a one-to-one manner for which a match is established under a predetermined condition; and
a template update step of updating a reference template by creating a template in which are set a cutout image having pixel values obtained by taking into account a predetermined amount of a pixel value of a cutout image of the pair reference template and a pixel value of a cutout image of the pair temporary template and the center coordinates of the pair temporary template; and retaining reference templates and temporary templates remaining from a match not being established for updating as reference templates.

10. The image processing method according to claim 9, wherein the predetermined condition is that a distance L pixels between center coordinates of the reference template and the temporary template to be matched is less than or equal to a predetermined threshold, and an SSD between cutout images is a minimum value that is less than or equal to a threshold.

11. The image processing method according to claim 10, wherein the predetermined amount is a pixel value that is the sum of a value obtained by multiplying a pixel value of a cutout image of the pair reference template by a predetermined ratio α and a value obtained by multiplying a pixel value of a cutout image of the pair temporary template by a predetermined ratio β (=1−α).

12. The image processing method according to claim 9, wherein, among reference templates remaining from a match not being established, reference templates that remain for a predetermined number of frames consecutively are deleted.

13. The image processing system according to claim 2, wherein, among reference templates remaining from a match not being established, reference templates that remain for a predetermined number of frames consecutively are deleted.

14. The image processing system according to claim 3, wherein, among reference templates remaining from a match not being established, reference templates that remain for a predetermined number of frames consecutively are deleted.

15. The image processing device according to claim 6, wherein, among reference templates remaining from a match not being established, reference templates that remain for a predetermined number of frames consecutively are deleted.

16. The image processing device according to claim 7, wherein, among reference templates remaining from a match not being established, reference templates that remain for a predetermined number of frames consecutively are deleted.

17. The image processing method according to claim 10, wherein, among reference templates remaining from a match not being established, reference templates that remain for a predetermined number of frames consecutively are deleted.

18. The image processing method according to claim 11, wherein, among reference templates remaining from a match not being established, reference templates that remain for a predetermined number of frames consecutively are deleted.
